(19) United States
(12) Patent Application Publication
(10) Pub. No.: US 2005/0172498 A1
(43) Pub. Date: Aug. 11, 2005

(54) Mechanical device with powered tool orientable along three orthogonal planes, particularly a device for agricultural and garden tools

(76) Inventor: Franco Castelmani, Gerano (IT)

Correspondence Address: John S. Egbert;Harrison & Egbert, 7th Floor, 412 Main Street, Houston, TX, 77002, US

(21) Appl. No.: 11/079,859

(22) Filed: Mar. 14, 2005

Related U.S. Application Data
(63) Continuation-in-part of application No. 10/337,472, filed on Jan. 7, 2003, now abandoned.

(30) Foreign Application Priority Data
Jan. 23, 2002 (IT) RM2002A000028

(51) Int. Cl. B26B 19/02

(52) U.S. Cl. 30/216

(57) ABSTRACT

The invention relates to a mechanical device with powered tool that can be oriented along the three orthogonal planes xy, yz and zx, said device providing a support rod, to support the same device and transferring the motion from the motion generating means to the tool, and a transmission and orientation element, said transmission and orientation element providing means for transmitting a reciprocating motion to the tool, and means for adjusting the orientation of the tool along a plane xy, said mechanical device being characterized said transmission and orientation element further provides means for adjusting the orientation of said tool along a plane yz within a range of about ±90°, said means being provided upward the means for transmitting a reciprocating motion to the tool, said device further providing means for adjusting the orientation of said tool along a zx plane within a full 360° range, said means being provided downward the means for transmitting a reciprocating motion to the tool, without interfering with the reciprocating motion.

### RELATED U.S. APPLICATIONS

The present application is a continuation-in-part application of U.S. Ser. No. 10/337,472, filed on Jan. 7, 2003, entitled “MECHANICAL DEVICE WITH OSCILLATING BLADES WHICH MAY BE MOVED ON ALL THE ORTHOGONAL PLANES”, presently pending.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a mechanical device with powered tool that can be oriented along the three orthogonal planes xy, yz and zx.

Particularly, the invention refers to a device of the above kind that can be used in the agricultural and gardening fields.

### BACKGROUND OF THE INVENTION

In the following the specification will be addressed to devices that are employed in the agricultural and gardening fields, but it is to be understood that the same inventive solution can be employed for any device provided with a tool that must have a reciprocating motion, and the position of which must be adjustable along the three planes xy, yz and zx.

In the last years, many solutions have been suggested for realizing devices aimed to improve the work of those having to cut bushes, branches, grass, and to mow lawns.

Particularly, known bush-cutters are applied to hedge trimmers and lawnmowers, by removing the bevel gear, and applying the suitable tool, provided with the two reciprocating blades.

These devices allow the adjustment of the position of the blades only along one plane, by adjustment of the coupling between the support arm and the tool support, the above not allowing to the user to properly use the bush-cutter, and limiting the possibility of working by the same.

In other words, known bush-cutters oblige the user to work in very inconvenient positions, or even they do not allow the same user to reach some working places, or prevent him/her from carrying out some operations.

It is well obvious that it would be very convenient and advantageous to have available a mechanical device as the one suggested according to the present invention, allowing the orientation of the tool along each plane xy, yz and zx, without limiting in any way the operation of the same tool (in the specific case the two cutting blades).

### BRIEF SUMMARY OF THE INVENTION

In order to reach this object, the inventor has solved some technical problems, mainly due to the need of combining the reciprocating motion of the tool with the possibility of modifying its orientation with respect to all the three planes xy, yz and zx without interfering with the same motion.

Specifically, the known mechanical devices are already provided with the orientation along the xy plane, the inventive solution allowing the possibility of orientation ±90° along plane yz, and 360° along plane zx.

It is therefore specific object of the present invention a mechanical device with a powered tool that can be oriented along the three orthogonal planes xy, yz and zx, said device providing a support rod, to support the same device and transferring the motion from the motion generating means to the tool, and a transmission and orientation element, said transmission and orientation element providing means for transmitting a reciprocating motion to the tool, and means for adjusting the orientation of the tool along a plane xy, said mechanical device being characterized said transmission and orientation element further provides means for adjusting the orientation of said tool along a plane yz within a range of about ±90°, said means being provided upward the means for transmitting a reciprocating motion to the tool, said device further providing means for adjusting the orientation of said tool along a zx plane within a full 360° range, said means being provided downward the means for transmitting a reciprocating motion to the tool, without interfering with the reciprocating motion.

Preferably, according to the invention, said means for adjusting the orientation of said tool along a plane yz within a range of about ±90° comprise a ratchet gear, is provided within the housing of said transmission and orientation element, on which a lever engages, said lever, provided outside said housing, being controlled by a button, provided with a release spring.

Particularly, according to the invention, mechanical stops are provided, in order to limit the movement of the device within the above range.

Always according to the invention, said means for adjusting the orientation of said tool along a zx plane within a full 360° range comprises at least one connecting rod element, transmitting the reciprocating motion, coupled with the tool by the interposition of a rotating joint.

Preferably, according to the invention, said tool provides two parallel blades, or other element, being provided a corresponding number of connecting rod element and of rotating joints.

Particularly, a first connecting rod element is coupled with a first rotating joint through the interposition of a sleeve, said sleeve being fixedly coupled with the first connecting rod element, rectilinearly translating with the same, said first rotating joint being centrally inserted within said translating sleeve, by the interposition of a bearing allowing its rotation while following the same sleeve during its translation.

Always according to the invention, a second connecting rod element is provided, coupled by the interposition of a plate and a threaded disc, to a second rotating joint.

According to the invention, said rotating joints are provided concentrically, so that, simply acting on an outer ring, it is possible changing the orientation of the blades along the plane zx, in the full range of 360°, without interfering with the reciprocating motion of the tool (blades).

### BRIEF DESCRIPTION OF THE SEVERAL VIEWS OF THE DRAWINGS

The present invention will be now described, for illustrative but not limitative purposes, according to its preferred embodiments, with particular reference to the figures of the enclosed drawings, wherein:

FIG. 1 is a schematic view of the positions that can be obtained along plane yz by the device according to the invention.

FIG. 2 is a schematic view of the positions that can be obtained along plane xy by the device according to the invention.

FIG. 3 is a perspective view of the tool coupled to the device according to the invention.

FIG. 4 is a schematic view of the transmission of the device according to the invention.

FIG. 5 is an exploded view of the device according to the invention.

FIG. 6 shows a particular of the device according to the invention; and

FIGS. 7a-7d show a second particular of the device according to the invention.

### DETAILED DESCRIPTION OF THE INVENTION

As already said, the specification will be particularly addressed to the use of the mechanical device for a bush-cutter, but the same inventive solution can be used for other tools, such as electrical knives, combs for collecting olives and coffee, etc.

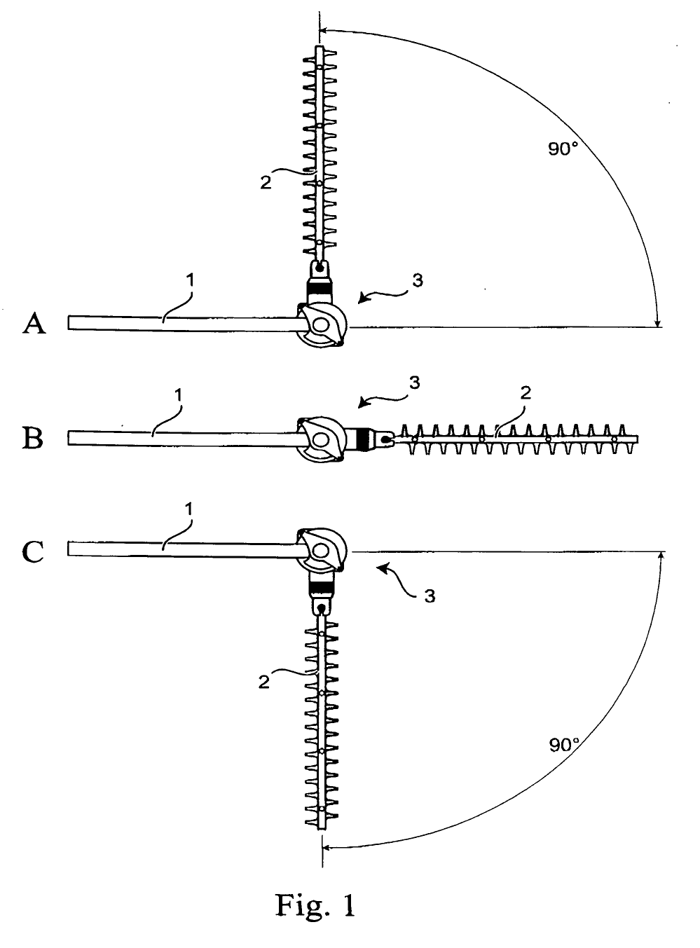

FIG. 1 generically shows a mechanical device providing a rod 1, a tool 2, particularly two cutting blades, and a transmission and orientation element, generically indicated by reference number 3.

Particularly, in FIG. 1, the positions that the device according to the invention can take along plane yz, namely in a range of ±90° are illustrated, said position being reachable by the inventive solution that will be described in greater detail in the following.

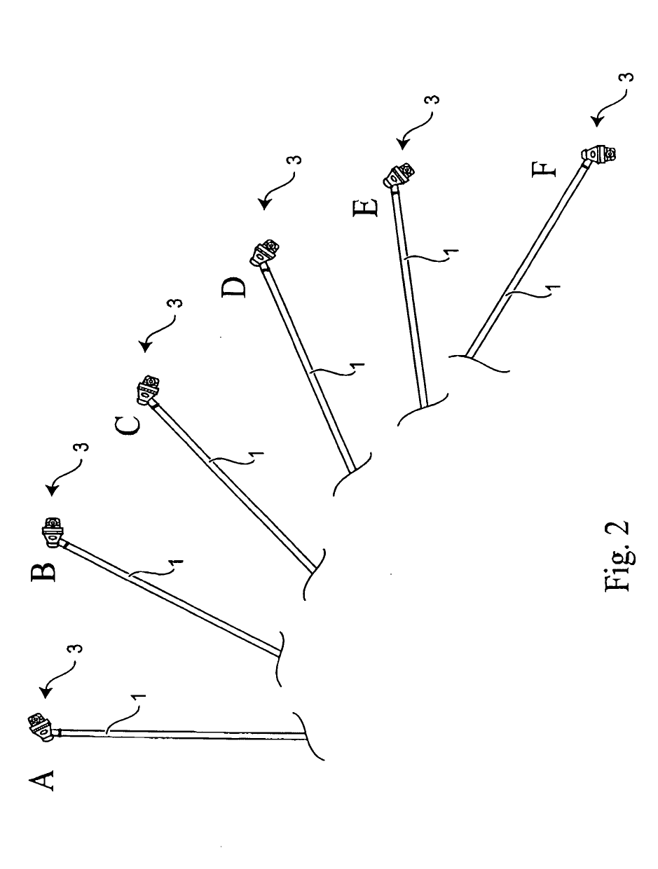

In FIG. 2, the same device is shown in the positions along the plane xy, said adjustment being already obtainable by the known solutions.

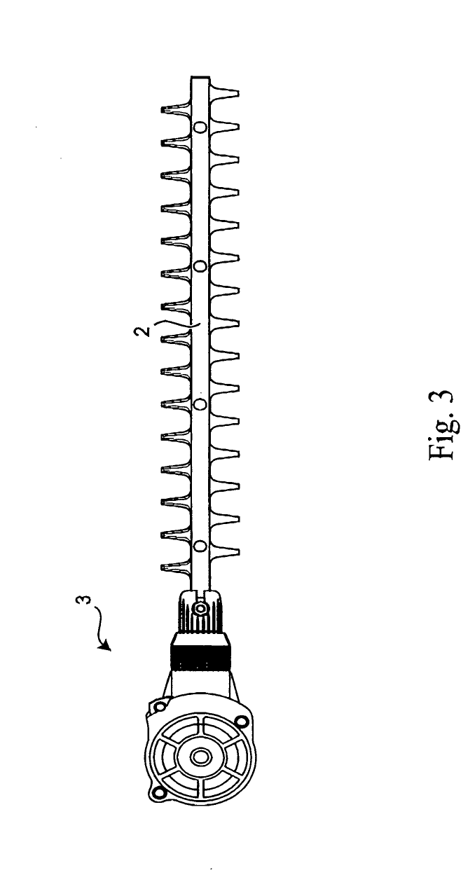

In FIG. 3 is sown the tool (cutting blades), and it is generically shown also the transmission and orientation element 3, said element 3 providing the solutions according to the invention.

Element 3 will be coupled with the support rod 1 by a device (not shown), which is per se known in the art, and that will be not described in further detail in the following, said device transmitting the motion from the powering unit (not shown), and allowing the orientation along plane xy (see FIG. 2).

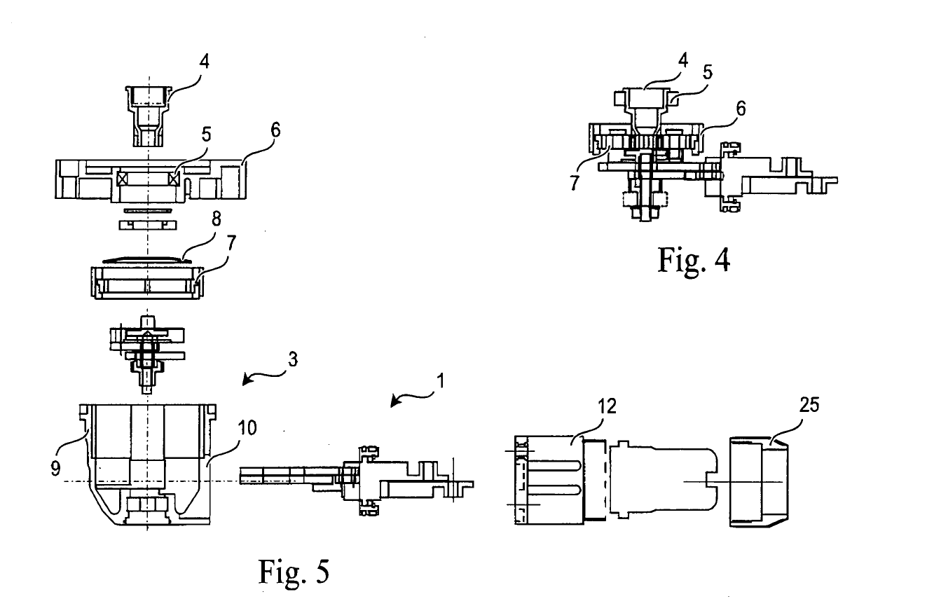

Transmission of the motion is obtained (see FIG. 4) by a mechanism, not inventive per se, comprising an output shaft 4, a bearing 5, a toothed gear 6, a pinion 7, and a spring 8. The same elements can be observed also in FIG. 5, showing an exploded view of the element 3, by which the inventive features can be initially understood.

The transmission illustrated in FIG. 4 is housed within the housing 9, said housing being frontally provided with an opening 10, through which the elements 11 (to be described in greater detail in the following) for transmitting the motion to the tool exit. A cover 12 for the coupling between the elements 11 and the cutting blades 12 are further provided.

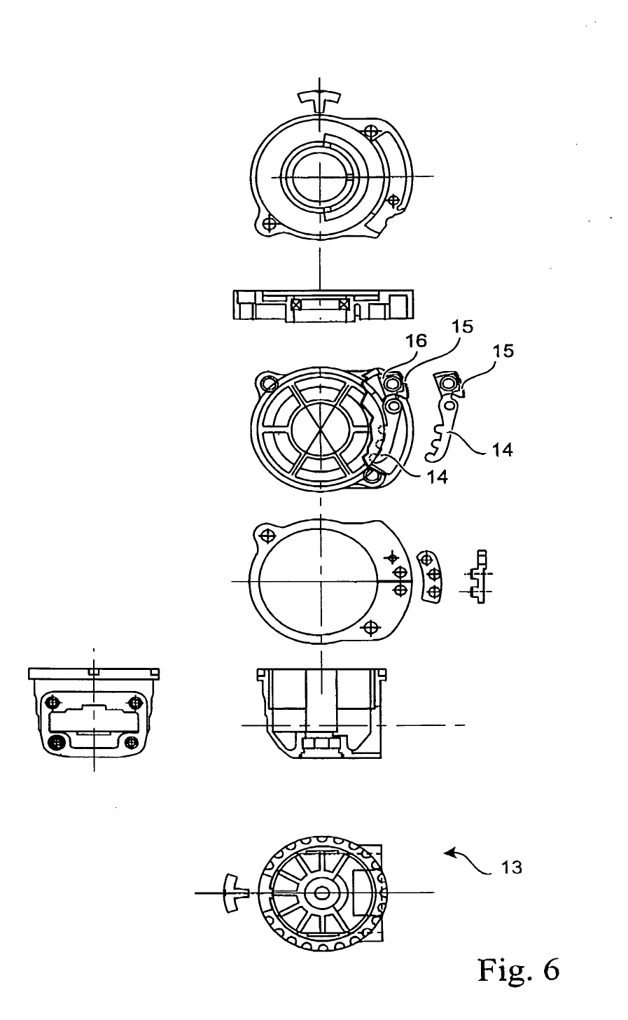

Coming now to observe FIG. 6, it is shown the technical solution allowing the orientation of the mechanical device according to the invention, allowing the adjustment along plane yz, as shown in FIG. 1.

A ratchet gear 13 is provided within the housing 9, on which a lever 14 engages. A button 15, provided with a release spring 16, can control said lever. Pushing the button 15, said lever 14 disengages from the ratchet gear 13, thus allowing the rotation of the axis of the tool 2 with respect to the support rod 1 along the plane yz within a range of ±90°. To this end, a mechanical stop (not shown) is provided in order to limit the movement of the device within the above range.

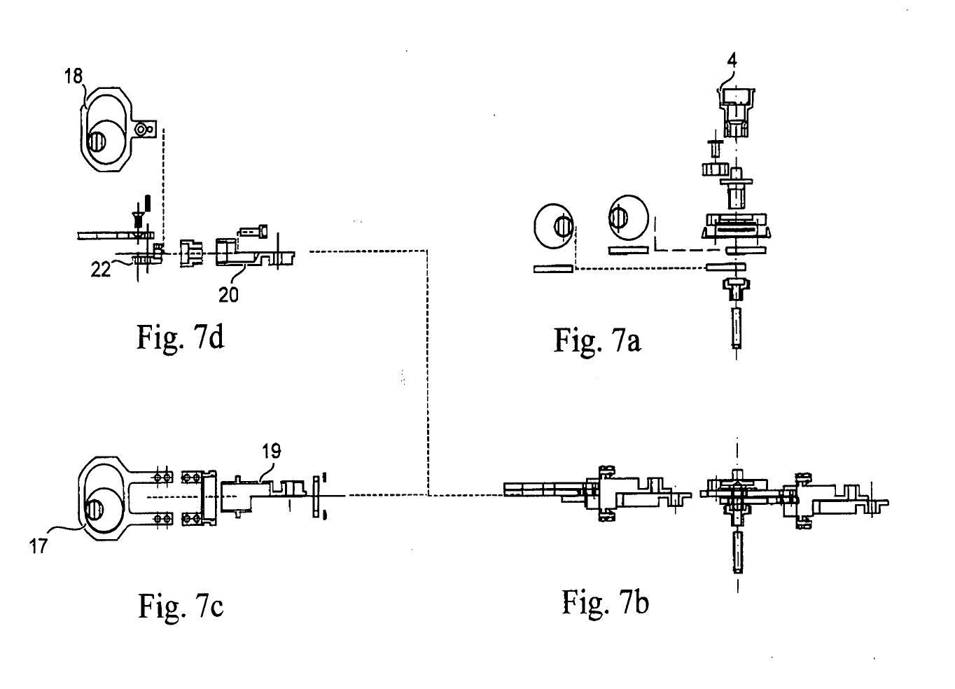

Coming now to observe FIGS. 7a-7d, it is shown the solution according to the present invention by which it is possible obtaining the orientation of the tool 2 along the plane zx, without interfering with the reciprocating motion of the same tool.

In order to obtain the reciprocating motion of the tool 2, the motion from the output shaft 4 to the same tools is transmitted by two connecting rod elements 17, 18 on which three eccentric elements act. Said mechanical transmission will be not described in greater detail, since it is not part of the present invention.

The technical problem solved by the invention is that of rotating of 360° the tool 2, without interfering with the reciprocating motion transmitted by the connecting rod elements 17, 18.

Said connecting rod elements 17, 18 are coupled with the tool 2, specifically with the two cutting blades 2, by the interposition of two rotating joints 19, 20.

Particularly, connecting rod element 17 is coupled with the rotating joint 19 through the interposition of a sleeve 21. Said sleeve 21 is fixedly coupled with the connecting rod element 17, rectilinearly translating with the same. The rotating joint 19 is centrally inserted within said translating sleeve 21, by the interposition of a bearing (not shown) allowing its rotation while following the same sleeve 21 during its translation. Since one of the blades 2 are coupled to the rotating joint 19, said blade is subjected to the reciprocating motion transmitted from the connecting rod element 17, the sleeve 21 and the rotating joint 19, but it can also be rotated, by acting only on the rotating joint 19.

The same occurs for the other blade 2, by the connecting rod element 18, coupled by the interposition of a plate 22 and a threaded disc 23, to the rotating joint 20.

Said rotating joints 19, 20 are provided concentrically, so that, simply acting on an outer ring 24 (see FIG. 5) it is possible changing the orientation of the blades 2 along the plane zx, in the full range of 360°, without interfering with the reciprocating motion of the tool 2 (blades).

The present invention has been described for illustrative but not limitative purposes, according to its preferred embodiments, but it is to be understood that modifications and/or changes can be introduced by those skilled in the art without departing from the relevant scope as defined in the enclosed claims.

1. Mechanical device comprising:
a powered tool orientable along three orthogonal planes xy, yz and zx;
a support rod, transferring motion from a motion generating means to the tool; and
a transmission and orientation element, being comprised of:
means for transmitting a reciprocating motion to the tool;
means for adjusting orientation of the tool along the plane xy;
means for adjusting orientation of said tool along a the plane yz within a range of about ±90°, said means for adjusting being positioned upward from the means for transmitting a reciprocating motion; and
means for adjusting orientation of the tool along a zx plane within a full 360° range, said means for adjusting being positioned downward from the means for transmitting a reciprocating motion, without interfering with the reciprocating motion.

2. Mechanical device according to claim 1, wherein said means for adjusting the orientation of said tool along a plane yz within a range of about ±90° comprises:
a ratchet gear, within a housing of said transmission and orientation element, on which a lever engages, said lever, being positioned outside said housing, and controlled by a button with a release spring.

3. Mechanical device according to claim 2, further comprising:
mechanical stops limiting movement of the tool within the range.

4. Mechanical device according to claim 1 wherein said means for adjusting the orientation of the tool along a zx plane within a full 360° range comprises
at least one connecting rod element, transmitting the reciprocating motion, coupled with the tool by the interposition of a rotating joint.

5. Mechanical device according to claim 1, wherein the tool comprises:
two parallel blades being provided a corresponding number of connecting rod elements and rotating joints.

6. Mechanical device according to claim 1 further comprising:
a first connecting rod element coupled with a first rotating joint through interposition of a sleeve, said sleeve being fixedly coupled with the first connecting rod element, rectilinearly translating with the first connecting rod element, said first rotating joint being centrally inserted within said translating sleeve, by interposition of a bearing allowing rotation while following the same sleeve during translation.

7. Mechanical device according to claim 6, further comprising:
a second connecting rod element coupled by the interposition of a plate and a threaded disc, to a second rotating joint.

8. Mechanical device according to claim 6, said rotating joints being concentric and acting on an outer ring, orientation of the tool along the plane zx, in the full range of 360°, being changeable without interfering with the reciprocating motion of the tool.
